(19) United States
(12) Patent Application Publication
(10) Pub. No.: US 2026/0071933 A1
(43) Pub. Date: Mar. 12, 2026

(54) METHOD AND SYSTEM FOR IDENTIFYING PIPELINE LEAKS USING A PIPELINE INSPECTION GAUGE

(71) Applicant: Pipesense, LLC, Clearbrook, MN (US)

(72) Inventors: Stuart Mitchell, Katy, TX (US); Scott Bauer, Sugar Land, TX (US); Dacosta Yeboah, Houston, TX (US); Dingding Chen, Tomball, TX (US)

(73) Assignee: Pipesense, LLC, Clearbrook, MN (US)

(21) Appl. No.: 19/320,791

(22) Filed: Sep. 5, 2025

Related U.S. Application Data
(60) Provisional application No. 63/691,848, filed on Sep. 6, 2024.

(51) Int. Cl. G01M 3/28

(52) U.S. Cl. CPC G01M 3/2823; G01M 3/2815

(57) ABSTRACT

A computer-implemented system and method for detecting an anomaly in a pipeline carrying fluids using a Pipeline Inspection Guage (PIG). Provided is a PIG configured to be placed into a fluid within the pipeline including one or more pressure measuring devices configured to receive pressure signals indicative of the one or more pressure parameters within the fluid flowing through the pipeline when the PIG is placed within the pipeline. The PIG includes a computer processor configured to provide detected pressure signals to an edge computing device for comparing the pressure signals to one or more anomaly detection thresholds to determine whether an anomaly event (e.g., a leak) is detected in the pipeline. The PIG computer processor preferably automatically generates an event report upon detection of an anomaly even, and may automatically issue an alert in the form of an event summary describing the anomaly.

### CROSS-REFERENCE TO RELATED APPLICATIONS

This application claims priority to and the benefit of U.S. Provisional Patent Application No. 63/691,848, filed Sep. 6, 2024, the entire content of which is incorporated by reference herein.

### BACKGROUND

### 1. Field

The disclosed embodiments generally relate to detecting pipeline leaks, and more particularly, to detecting pipeline leaks by detecting signals indicative of a leak in a pipeline by a Pipeline Inspection Guage (PIG).

### 2. Description of Related Art

Pipelines are critical infrastructure for transporting fluids such as water, oil, natural gas, and other industrial liquids over long distances. These pipelines often traverse challenging terrains and extend through densely populated or ecologically sensitive areas. Ensuring the integrity of these pipelines is essential to prevent leaks, which can lead to significant economic losses, environmental damage, safety hazards, and regulatory penalties.

For instance, the need for detecting pipeline leaks extends to: 1) Environmental and Safety Concerns—a leak in a pipeline can result in the uncontrolled release of hazardous substances, leading to severe environmental contamination. For example, oil spills can devastate marine and terrestrial ecosystems, while gas leaks can lead to explosions and fires, endangering human lives and property. The timely detection of leaks is vital to mitigate these risks by enabling rapid response measures to contain and repair the damage. 2) Economic Impact—pipeline leaks result in the loss of valuable products. In industries where high-value fluids are transported, even minor leaks can lead to substantial financial losses over time. Repairing leaks and the associated downtime for pipelines can be costly. Additionally, undetected leaks can cause pipeline corrosion, leading to more severe damage and higher repair costs. And 3) Regulatory Compliance—governments and regulatory bodies impose strict regulations on pipeline operators to ensure safety and environmental protection. Failure to detect and address leaks promptly can result in heavy fines and legal liabilities. There is an increasing push for more stringent monitoring and reporting requirements, driving the need for advanced leak detection technologies.

A variety of approaches to leak detection are currently used in the relevant industry. Many approaches require some form of active observation along the length of the pipeline or the surrounding area. These previous attempts range from the most basic-physically driving along the pipeline and visually inspecting for leaks—to advanced technologies involving drones with hyperspectral imaging or gas analyzers used to detect leaking particles of product on the order of a few parts-per-million. All physical inspection techniques are costly and time consuming.

Many attempts have been made to detect and locate media leaks using pressure sensors with or without flow meters. The most fundamental approach involves monitoring pressure and flow values and comparing those values against predetermined thresholds. Traditional leak detection methods, such as manual inspections or simple pressure monitoring, are often inadequate for early detection, especially in long-distance or underground pipelines. Advances in technology, such as sensor networks, real-time data analytics, and machine learning, offer new opportunities to enhance leak detection capabilities. However, these technologies must be integrated effectively into existing pipeline monitoring systems to provide accurate, reliable, and timely detection of leaks.

Pipelines can also periodically be subject to integrity testing by means of an elevated pressure test. During the testing process, pipeline leaks can also occur or become evident by means of the pipeline section being tested being unable to hold pressure. Traditional methods for locating such leaks often involve introducing a trace gas or dye into the test medium and externally detecting the location of the leak. Other methods involve repeated temporary isolation of sections of the pipeline using liquid Nitrogen to freeze the test medium and looking for a reduction in the test pressure. All of these methods are again costly and time consuming for the pipeline operator.

Given the critical importance of minimizing fluid leaks in pipelines, there is a pressing need for innovative methods and systems that can detect leaks accurately and in real-time. Such systems must be capable of operating under diverse environmental conditions, providing pipeline operators with actionable insights to maintain the integrity of their infrastructure. This need has driven the development of advanced leak detection technologies that leverage modern sensing, data analysis, and communication techniques to enhance the safety, reliability, and efficiency of pipeline operations.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a method and system for detecting a leak in a pipeline carrying fluids using a Pipeline Inspection Guage (PIG) is described, in which a PIG is introduced (inserted) into a first region of a pipeline. It is to be appreciated and understood that a pipeline leak in certain illustrated embodiments is detected via detection of an acoustic signal by an acoustic sensor. However, the illustrated embodiments are not to be limited thereto as they may detect a pipeline leak via detection of pressure signal by a pressure sensor.

The PIG is then caused to move along the longitudinal axis of the inner diameter of the Pipeline, and is configured and operative to detect, by an acoustic sensor assembly provided in the PIG, an acoustic signal indicative of a leak in the pipeline when the moving PIG is located in close proximity to the pipeline leak. Once a pipeline leak is detected by the PIG, movement of the PIG in the pipeline is caused to stop, such that the PIG is now stopped in the pipeline in close proximity to the detected pipeline leak. A distance the stopped PIG is from the first region of the of the pipeline is then determined, which distance is indicative of a distance the detected pipeline leak is from the first region of the pipeline.

In other aspects, a Pipeline Inspection Guage (PIG) is described that is configured and operative to detect a leak in a pipeline by detecting an acoustic signal associated with a pipeline leak. In accordance with certain exemplary illustrated embodiments, the PIG has a cylindrical housing having an outer diameter wall configured to substantially form a seal with the inner diameter of the pipeline when the PIG is located in the inner diameter of the pipeline. The PIG includes an inner cavity portion defined by inner cavity walls. An acoustic sensor assembly is provided in inner cavity portion, preferably being configured and operative to detect an acoustic signal indicative of a leak in the pipeline when the PIG is located in close proximity to the leak in the pipeline.

In accordance with at least one aspect of this disclosure, a computer-implemented system for detecting an anomaly in a pipeline carrying fluids using a Pipeline Inspection Guage (PIG), comprises, a PIG configured to be placed into a fluid within the pipeline, one or more pressure measuring devices disposed on or in the PIG configured to receive pressure signals indicative of the one or more pressure parameter within the fluid flowing through the pipeline, and a processor. The processor can be configured to, or in certain embodiments cause a computer to: provide the pressure signals to an edge computing device for comparing the pressure signals to one or more anomaly detection thresholds to determine whether an anomaly is detected in the pipeline, automatically generate an event report upon detection of the anomaly, and automatically issue an alert in the form of an event summary describing the anomaly.

In certain embodiments, the one or more pressure parameters include a fluid pressure and the one or more pressure measuring devices includes a fluid pressure sensor. In certain embodiments, the one or more pressure parameters include an acoustic pressure measurement and the one or more pressure measuring devices further includes an acoustic pressure sensor, e.g., a hydrophone.

The fluid pressure sensor and the acoustic pressure sensor can be further configured to simultaneously and continuously measure both a fluid pressure and an acoustic pressure within the fluid flowing through the pipeline while the PIG is in the pipeline. Thus, the one or more pressure signals include fluid pressure signals indicative of the fluid pressure and the acoustic pressure signals indicative of the acoustic pressure. In certain such embodiments, the processor is further configured to convert the one or more pressure signals from analog pressure signals to digital pressure signals, where the fluid pressure signals indicative of the fluid pressure are converted via a first signal analog to digital converter and provided to the edge computing device via a first signal stream, and the acoustic pressure signals indicative of the acoustic pressure are converted via a second analog to digital converter and provided to the edge computing device via a second signal stream. In certain embodiments, each signal stream can be siloed within the edge computing device.

In certain embodiments, the edge computing device is configured to sample the first signal stream at a first sampling rate (e.g., a rate sufficient to capture pressure fluctuations relevant to leak detection and flow disturbances without generating excessive data volume) and sample the second signal stream at a second sampling rate different from the first sampling rate (e.g., a rate enabling detection of acoustic signatures of interest). The first sampling rate and the second sampling rate can be determined as a function of signal type. For example, the first sampling rate (for sampling the fluid pressure measurements) can be at a rate of about 1 kHz while the second sampling rate (for sampling the acoustic pressure measurements) can be higher, at a rate of about 60 kHz.

In certain embodiments, the edge computing device can be further configured to employ a first detection algorithm on signal data from the first signal stream to determine whether an anomaly is present in the pipeline based on the comparison of the fluid pressure signals to a first anomaly detection threshold, and employ a second detection algorithm on signal data from the second signal stream to determine whether an anomaly is present in the pipeline based on the comparison of the acoustic pressure signals to a second anomaly detection threshold.

In certain embodiments, the edge computing device can be further configured to, after an anomaly is detected by either of the first detection algorithm or the second detection algorithm, capture a portion of the signal stream indicating the anomaly as an anomaly window; and perform one or more data processing techniques on the anomaly window to determine whether the anomaly is an anomaly requiring action by a user. The one or more data processing techniques can be or include any one or combination of the following techniques.

In certain embodiments, the one or more data processing techniques can include performing time-frequency analysis on the anomaly window using continuous wavelet transform to obtain calculated values quantifying a presence and an intensity of an anomaly signature within the anomaly by comparing the calculated values to the first anomaly threshold and/or the second anomaly detection threshold In certain embodiments, the one or more data processing techniques can include performing feature extraction on the anomaly signature using principal component analysis to identify components of the anomaly signature of high significance by assigning a respective significance score,

In certain embodiments, the one or more data processing techniques can include performing feature classification using one or more artificial intelligence (AI) techniques to classify the components of the anomaly signature of having a high significance score as one or more predetermined anomaly types based on their respective significance score.

In certain embodiments, the one or more predetermined anomaly types include being detected by the system described herein can include a newly identified leak, a pre-existing leak, a pig-sig, a farm tap, a dresser, and/or a weld spot. In certain embodiments, the processor can be further configured to automatically generate the event report upon detection of an anomaly having a significance score matching one of the predetermined anomaly types in either the first signal stream or the second signal stream where the event report identifies the anomaly type. The processor can be further configured to issue the alert via a low bandwidth acoustic modem to a remote receiver dedicated to receiving the event report.

In accordance with at least one aspect of this disclosure, a Pipeline Inspection Guage (PIG) for detecting an anomaly in a pipeline carrying fluid, comprises a spool shaped housing having a forward portion and a rear portion, the forward and rear portions each having an outer wall configured form a seal with an inner diameter of the pipeline with the PIG placed in the pipeline; a hollow core extending between the forward portion and the rear portion along an axis configured to house one or more functional components. In certain embodiments, the one or more functional components can be or include, one or more pressure measuring devices for measuring one or more pressure parameters within the fluid flowing through the pipeline to receive pressure signals indicative of the one or more pressure parameters and a communications module configured to provide issue an alert to a remote device indicative of an anomaly detected in the pipeline based on the pressure signals. In certain embodiments, the one or more pressure measuring devices include a fluid pressure transducer and an acoustic transducer.

In certain embodiments, the rear portion of the housing includes one or more flow apertures defined therein to allow fluid in the pipeline to flow through the rear end and into the hollow core. In certain such embodiments, the one or more functional components further include: a first valve disposed in a wall of the hollow core configured to selectively actuate between an open position and a closed position, and a second valve disposed in the forward portion configured to selectively actuate between an open and closed position. With the first valve in the open position and the second valve in the closed position, fluid from the pipeline is permitted to flow from the hollow core into an annular space axially between the forward portion and the rear portion, pushing against the forward portion propelling the PIG through the pipeline. With the first valve in the open position and the second valve in the open position, fluid from the pipeline is permitted to flow from the hollow core into the annular space axially between the forward portion and the rear portion and through the second valve, stalling the PIG in place. In certain embodiments, the second valve is configured to automatically actuate from the closed position to the open position upon detection of the anomaly.

In certain embodiments, the communications module can further include, a first analog to digital converter configured to convert analog pressure signals indicative of a fluid pressure in the pipeline into a first digital signal stream, and a second analog to digital converter configured to convert analog pressure signals indicative of an acoustic pressure in the pipeline into a second digital signal stream. In certain such embodiments, the communications module is configured to provide the first digital signal stream and the second digital signal stream to the remote device.

In certain embodiments, the remote device can be an edge computing device and each signal stream is siloed within the edge computing device. In certain such embodiments, the edge computing device can be configured to sample the first signal stream at a first sampling rate and sample the second signal stream at a second sampling rate different from the first sampling rate, wherein the first sampling rate and second sampling rate are determined as a function of signal type.

The PIG can further include the edge computing device, and the edge computing device can be configured to employ a first detection algorithm on signal data from the first signal stream to determine whether an anomaly is present in the pipeline based on the comparison of the fluid pressure signals to a first anomaly detection threshold, and employ a second detection algorithm on signal data from the second signal stream to determine whether an anomaly is present in the pipeline based on the comparison of the acoustic pressure signals to a second anomaly detection threshold.

In certain embodiments, the edge computing device can be further configured to, after an anomaly is detected by either of the first detection algorithm or the second detection algorithm, capture a portion of the signal stream indicating the anomaly as an anomaly window and perform one or more data processing techniques on the anomaly window to determine whether the anomaly is an anomaly requiring action by a user. In certain embodiments, the one or more data processing techniques can include any one or combination of the following described techniques.

In certain embodiments, the one or more data processing techniques can include performing time-frequency analysis on the anomaly window using continuous wavelet transform to obtain calculated values quantifying a presence and an intensity of an anomaly signature within the anomaly by comparing the calculated values to the first anomaly threshold and/or the second anomaly detection threshold.

In certain embodiments, the one or more data processing techniques can include performing feature extraction on the anomaly signature using principal component analysis to identify components of the anomaly signature of high significance by assigning a respective significance score.

In certain embodiments, the one or more data processing techniques can include performing feature classification using one or more artificial intelligence (AI) techniques to classify the components of the anomaly signature of having a high significance score as one or more predetermined anomaly types based on their respective significance score. The one or more predetermined anomaly types can include: a newly identified leak, a pre-existing leak, a pig-sig, a farm tap, a dresser, and/or a weld spot.

In certain embodiments, the edge computing device can be further configured to, upon detection of the anomaly, automatically generate an event report of an anomaly having a significance score matching one of the predetermined anomaly types in either the first signal stream or the second signal stream where the event report identifies the anomaly type.

In certain embodiments, the one or more functional components can further include an alert assembly positioned within the hollow core closer to the rear portion than the forward portion, the alert assembly including a third valve configured to acuate upon detection of an anomaly within the pipeline. Actuation of the third valve generates a pressure pulse signal, into the fluid provided in the pipeline and through the fluid in the pipeline to the remote device.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates a PIG device in accordance with the illustrated embodiments;

FIG. 2 illustrates use of the PIG device of FIG. 1 in a pipeline for detecting a pipeline leak in accordance with the illustrated embodiments;

FIG. 3 illustrates use of the PIG device of FIG. 1 in a pipeline for detecting a pipeline leak in accordance with the illustrated embodiments, where the PIG device is shown moving to a position adjacent an anomaly in the pipeline;

FIG. 4 illustrates use of the PIG device of FIG. 1 in a pipeline for detecting a pipeline leak in accordance with the illustrated embodiments where the PIG device is shown sending an alert to a remote device;

FIG. 5 illustrates use of the PIG device of FIG. 1 in a pipeline for detecting a pipeline leak in accordance with the illustrated embodiments where the PIG device is shown adjacent an anomaly in the pipeline and sending an alert to a remove device;

FIG. 6 illustrates use of the PIG device of FIG. 1 in a pipeline for detecting a pipeline leak in accordance with the illustrated embodiments where the PIG device is shown stalled in the pipeline adjacent the anomaly;

FIG. 7 illustrates use of the PIG device of FIG. 1 in a pipeline for detecting a pipeline leak in accordance with the illustrated embodiments where the PIG device is shown adjacent an anomaly in the pipeline, and where the alert is received by the remove device;

FIG. 8 illustrates use of the PIG device of FIG. 1 in a pipeline for detecting a pipeline leak in accordance with the illustrated embodiments where the PIG device is shown adjacent an anomaly in the pipeline, and where a distance from an end of the pipeline to the anomaly is calculated;

FIG. 9 schematically illustrates a PIG device in accordance with another illustrated embodiment;

FIG. 10 illustrates use of the PIG device of FIG. 9 in a pipeline for detecting a pipeline leak in accordance with the illustrated embodiments;

FIG. 11 schematically illustrates a block diagram of a hardware and software process system integration in accordance with the illustrated embodiments;

FIG. 12 schematically illustrates a general workflow for dual sensor real-time signal processing during pig run for pre-existing leak detection;

FIG. 13 shows example measurements from a pressure transducer to a moving PIG with multiple signatures;

FIG. 14a shows high dimensional CWT coefficients calculated from example pressure measurement data from a pressure transducer around a PIG-SIG at a first sampling time;

FIG. 14b shows reduced dimensional PCA scores calculated from example pressure measurement data from a pressure transducer around a PIG-SIG at the first sampling time;

FIG. 15a shows high dimensional CWT coefficients calculated from example pressure measurement data from a pressure transducer around a leak point at the first sampling time;

FIG. 15b shows reduced dimensional PCA scores calculated from example pressure measurement data from a pressure transducer around a leak point at the first sampling time;

FIG. 16 shows example measurements from an acoustic transducer to a moving PIG with multiple signatures;

FIG. 17a shows high dimensional CWT coefficients calculated from example pressure measurement data from an acoustic transducer around a PIG-SIG at a second sampling time;

FIG. 17b shows reduced dimensional PCA scores calculated from example pressure measurement data from an acoustic transducer around a PIG-SIG at the second sampling time;

FIG. 18a shows high dimensional CWT coefficients calculated from example pressure measurement data from a pressure transducer around a leak point at the second sampling time; and

FIG. 18b shows reduced dimensional PCA scores calculated from example pressure measurement data from a pressure transducer around a leak point at the second sampling time.

### DETAILED DESCRIPTION OF CERTAIN EMBODIMENTS

Aspects of the disclosed embodiments are shown in the following description and related drawings directed to specific illustrated embodiments. Alternate preferred embodiments may be devised without departing from the scope of the illustrated. Additionally, well-known elements of the illustrated embodiments will not be described in detail or will be omitted so as not to obscure the relevant details of the illustrated embodiments.

The word “exemplary” is used herein to mean “serving as an example, instance, or illustration.” Any embodiment described herein as “exemplary” is not necessarily to be construed as preferred or advantageous over other embodiments. Likewise, the term “illustrated embodiments” does not require that all illustrated embodiments include the discussed feature, advantage or mode of operation.

The terminology used herein is for the purpose of describing particular embodiments only and is not intended to be limiting of the illustrated embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiments may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Where a range of values is provided, it is understood that each intervening value, to the tenth of the unit of the lower limit unless the context clearly dictates otherwise, between the upper and lower limit of that range and any other stated or intervening value in that stated range is encompassed within the illustrated embodiments. The upper and lower limits of these smaller ranges may independently be included in the smaller ranges is also encompassed within the illustrated embodiments, subject to any specifically excluded limit in the stated range. Where the stated range includes one or both of the limits, ranges excluding either both of those included limits are also included in the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

The illustrated embodiments relate to an advanced pipeline inspection tool, commonly referred to as a “PIG” (Pipeline Inspection Gauge or Pipeline Intervention Gadget). It is to be understand and appreciated, leaks, such as small pipeline leaks (e.g., less than 2 mm) typically emit high frequency sounds such as in the ultrasonic range (e.g., 0.1 kHz to 100 kHz) that are capable of being detected by acoustic sensors configured to detecting such high frequency acoustic signals.

It is to be understood and appreciated pipeline PIGs are tools that are inserted into pipelines to perform various tasks, such as cleaning debris, inspecting the interior surface for defects, or coating the inside of the pipeline. Traditional PIGs are often propelled by the fluid flow within the pipeline, allowing them to travel through the pipeline's length and perform their designated functions. A conventional PIG is designed to perform multiple tasks in a single pass through the pipeline. It typically included cleaning elements, such as brushes or scrapers, that remove debris and scale from the pipeline walls. Additionally, it has been equipped with sensors and detection systems, such as ultrasonic transducers, magnetic flux leakage sensors, or eddy current probes, to identify and record defects like cracks, corrosion, or metal loss. Typically, a PIG features a modular design, allowing for the customization of its components based on the specific needs of the pipeline. Modules can be added or removed to adjust the PIG's functionality, such as adding additional inspection tools or enhancing cleaning capacity. Additionally, PIGs have collected inspection data by various sensors, which data is stored in onboard memory or transmitted in real-time to an external monitoring station. It is to be understood and appreciated a PIG is typically designed to adapt to varying pipeline conditions, such as changes in diameter, bends, or elevation. It may include flexible components that allow it to navigate through complex pipeline geometries while maintaining contact with the pipeline walls for effective cleaning and inspection. A PIG may be propelled by the fluid flow within the pipeline or by an internal propulsion mechanism, such as a motorized drive system. It also may include control systems that allow operators to adjust the PIG's speed, direction, and functions as needed.

The pipeline PIG described in accordance with the illustrated embodiments provides an advanced pipeline PIG (10) configured and operative to detect acoustic signals (300) in a pipeline fluid flow (100) that are associated with a pipeline leak (200). Additionally, the illustrated embodiments, as described herein, provides a method and system for acoustically detecting a leak (200) in a pipeline (150) carrying fluids (100) using a PIG (10), and determining a distance the PIG (10) is from a first region (50) of the of the pipeline (150), wherein this distance is indicative of a distance the leak (200) is from the first region (50) of the pipeline (150). It is to be appreciated and understood a pipeline leak in certain illustrated embodiments is detected via detection of an acoustic signal by an acoustic sensor. However, the illustrated embodiments are not to be limited thereto, as they may detect a pipeline leak by other types of sensor components, such as by a pressure sensor. For ease of description purposes only, the below described illustrated embodiments are described with reference to utilizing an acoustic sensor (32) for detecting acoustic signals (300) indicative of a pipeline leak (200), however, and as mentioned above, the embodiments are not to be understood to be limited to such an acoustic sensor for detecting signals indicative of a leak.

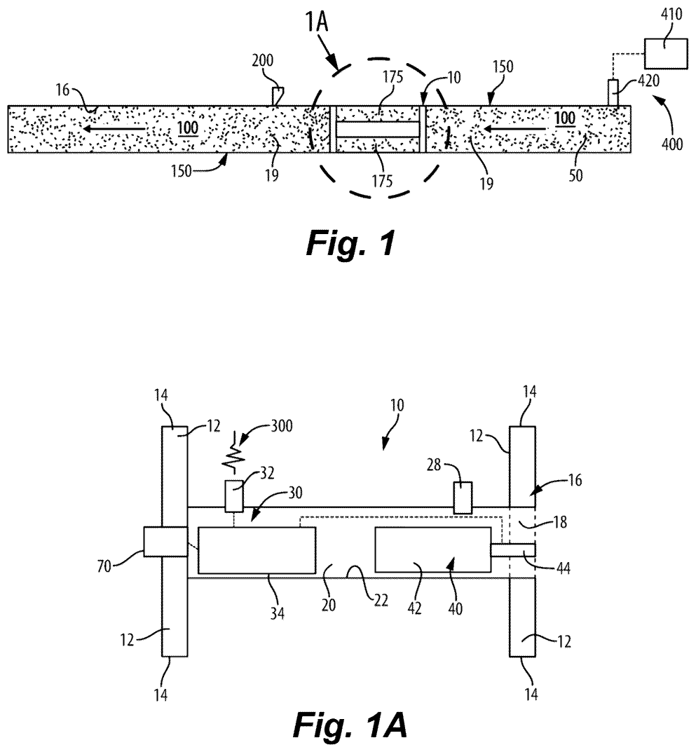

In accordance with an exemplary illustrated embodiment, starting with reference to FIG. 1, described below is a PIG 10 configured and operative to detect acoustic signals 300 in a pipeline fluid flow 100 that are associated with a pipeline leak 200. The PIG 10 is shown to preferably have am H-shaped cylindrical housing 12 (but is not limited thereto) having an outer diameter wall 14 configured to substantially form a seal with the inner diameter wall 16 of the pipeline 150 when the PIG 10 is located in the inner diameter 19 of the pipeline 150. In accordance with the illustrated embodiments, the PIG 10 is configured to have an inner cavity portion 20 defined by inner cavity walls 22. An acoustic sensor assembly 30 is preferably provided in the inner cavity portion 20 of the PIG 10. It is to be appreciated and understood, that in alternative embodiments, the acoustic sensor assembly 30 is located in the annular region between the seals (12) attached to the inner cavity walls (22), or alternatively, may be constructed to form the inner cavity walls in place of the PIG body for smaller sized pigs.

The acoustic sensor assembly 30 is preferably configured and operative to detect an acoustic signal 300 indicative of a leak 200 in the pipeline 150 when the PIG 10 is located in close proximity to the leak 200 in the pipeline 150 (as shown in FIG. 3). The acoustic sensor assembly 30 may include one or more acoustic sensor components 32 affixed to a portion of the cavity walls 22 of the inner cavity portion 20 of the PIG 10. An example of such an acoustic sensor component (32) may consist of a passive hydrophone sensor component. A hydrophone sensor component is an ultra-compact receive-only transducer consisting of piezoelectric sensing element (PZT). The sensitivity range can be 0.1 Hz to 100 KHz. Additionally, other acoustic sensing components may utilize electromagnetic acoustic transducers (EMAT) by employing a magneto-strictive effect to transmit and receive ultrasonic waves.

The acoustic sensor assembly 30 may further include an acoustic signal processing unit 34 located in the inner cavity portion 20 of the PIG 10. The acoustic signal processing unit 34 is preferably operatively coupled to the one or more acoustic sensors 30 and is configured and operative to determine if an acoustic signal 300 detected by the one or more acoustic sensors 32 is indicative of a leak 200 in the pipeline 150.

In accordance with the illustrated embodiments, the PIG 10 further includes a leak signal generation component/assembly 40 located in the inner cavity portion 20 of the PIG 10. The leak signal generation component 40 is preferably operatively coupled to the acoustic sensor assembly 30, so as to be operative and configured such that when the acoustic sensor assembly 30 detects an acoustic signal 300 indicative of a leak 200 (e.g., FIG. 3), the leak signal generation component 40 is caused to transmit a leak detection signal 350 from the PIG 10 into pipeline fluid flow 100 indicative of the detected leak 200 by the acoustic sensor assembly 30. In certain illustrated embodiments, the leak detection signal 350 is a pressure pulse signal, transmitted from the leak signal generation component/assembly 40 into the pipeline fluid flow 100, which is preferably causing propulsion of the PIG 10 in the pipeline 150. For instance, the leak signal generation component 40 may include a gas cylinder assembly 42 configured and operative for providing the pressure pulse signal 350 which constitutes the leak detection signal. In certain illustrated embodiments, the leak signal generation component/assembly 40 further includes an actuated valve component 44 coupled to the gas cylinder assembly 42 being configured and operative for providing the pressure pulse signal 350 from the gas cylinder assembly 42. It is to be appreciated and understood, in accordance with the illustrated embodiments, the acoustic sensor assembly 30 (preferably the acoustic signal processing control unit 34) is configured and operative to actuate the valve component 44 so as to cause a release of gas (upon detection of a leak 200), from the gas cylinder 42, to exit the housing 12 of the PIG 10 and into the pipeline fluid flow 100 so as to cause the aforesaid pressure pulse signal 350 (indicative of detection of a pipeline leak 200 by the acoustic sensor assembly 42), as will be further described below.

With continued reference to FIG. 1, and in accordance with the illustrated embodiments, a portion of the PIG 10 extending between the inner cavity walls 22 of its inner cavity portion 20 and the outer cylindrical diameter wall 16 of the pipeline 150 is preferably filled with fluid 175. Preferably, the fluid 175 provided between the cavity walls 22 of its inner cavity portion 20 and the outer cylindrical diameter pipeline wall 16 is provided by the pipeline fluid flow 100. In certain embodiments, the PIG 10 includes a fluid valve/damper component 28 extending through a portion of the cavity wall 22 of the inner cavity portion 20 so as to provide damping between the fluid in the pipeline (100), fluid in the inner cavity (22) and the fluid between the outer cavity wall (20) and the pipeline wall (16) for providing a pressure damped environment from any external pressure or acoustic noise(s) in the pipeline fluid 100, thus providing increased detection of an acoustic or pressure signal for detecting a pipeline leak. In accordance with the illustrated embodiments, a first end region 16 of the PIG 10 has an open portion 18 such that fluid 175 is caused to flow from the pipeline fluid flow 100, into its inner cavity portion 20, and between the cavity walls 22 of its inner cavity portion 20 and the outer cylindrical diameter pipeline wall 16.

In certain other illustrated embodiments of the PIG 10, a bypass valve component/assembly 70 is provided in the housing 12 of the PIG 10, which is preferably operatively coupled to the acoustic sensor assembly 30 (e.g., the acoustic signal processing control unit 34). Preferably under control by the acoustic sensor assembly 30, the bypass valve component/assembly 70 is operative and configured to, upon detection of a leak 200 by the acoustic sensor assembly 30, to move to an open position so as to permit pipeline fluid flow 175 to pass through the inner cavity 20 of the PIG 10 thereby stopping movement of the PIG 10 in the pipeline 150, as further described below.

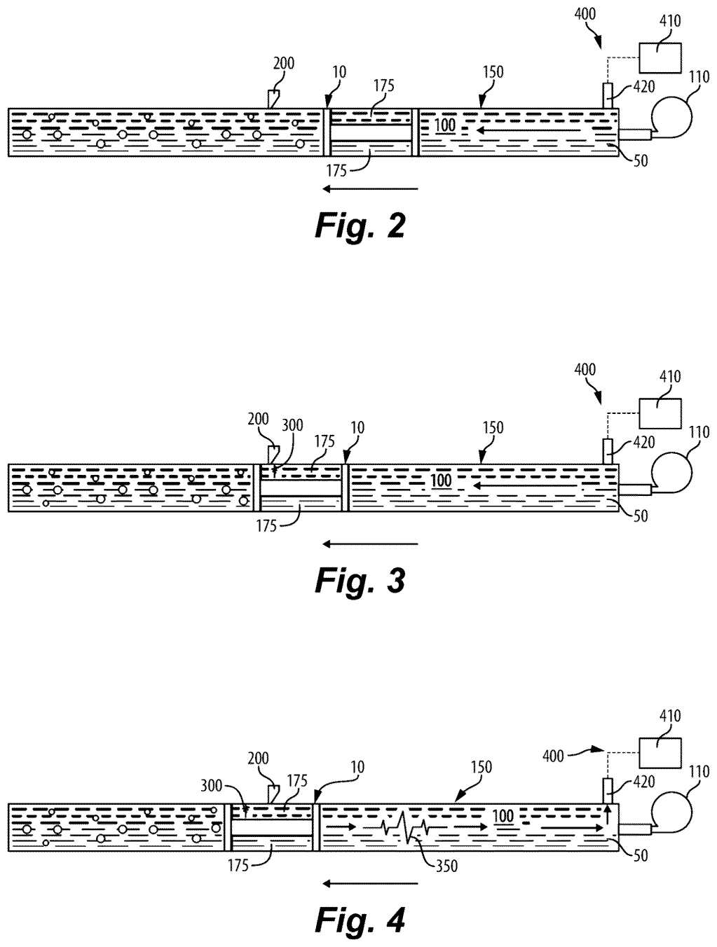

With one or more exemplary illustrated embodiments of the PIG 10 being described above with reference to FIG. 1, described now with reference to FIGS. 2-7 (and with continuing reference to FIG. 1) is a method and system for acoustically detecting a leak 200 in a pipeline 150 carrying fluids 100 using a PIG 10, as described above with reference to FIG. 1. The PIG 10 is preferably introduced by an operator/user into a first region 50 of the inner diameter of the pipeline 150. Once inserted in the pipeline 150, the PIG 10 is caused to move along the longitudinal axis of the inner diameter of the Pipeline 150. In accordance with the illustrated embodiments, the PIG 10 is caused to move in the pipeline 10, preferably via pressure impacted upon it by fluid flow 100 (e.g., water), preferably caused by a pumping source/assembly 110. It is to be appreciated and understood, that the exemplary illustrated embodiments for FIGS. 2-5 illustrate the use of water during a hydrotest scenario, and with regard to FIG. 6, the fluid flowing 100 in the pipeline is not to be limited to such a hydrotest scenario, as it may be any flowing product that is within the pipeline 150. For instance, it is to be understood and appreciated that for either a hydrotest scenario, or an operating pipeline scenario, the PIG 10 can be stopped by either stopping of the pump (110) (e.g., a hydrotest scenario) or by actuation of a bypass valve (70) (e.g., an operating pipeline scenario).

With reference to FIG. 2, while moving along the longitudinal axis of the pipeline 150, the PIG 10 is operative and configured to detect by its acoustic sensor assembly 30, an acoustic signal 300 indicative of a leak 200 in the pipeline 200 that is located in close proximity to current position of the PIG 10. With reference now to FIG. 4, upon detection of the acoustic signal 300 indicative of a leak 200 in the pipeline 200, the signal generating component 40 of the PIG 10 (preferably under instruction by the acoustic sensor assembly 30) is caused to transmit a leak detection signal 350 from the PIG 10 to preferably a leak signal detection assembly 400 provided at the first region 10 of the pipeline 150. In accordance with certain illustrated embodiments, the leak signal detection assembly 400 preferably includes a signal processing device 410 operatively coupled to a pressure sensor manifold component 420. This leak signal detection assembly 400 is operative and configured to detect a distance the PIG 10 is located from the first region 10 of the pipeline 150 upon detection of the leak detection signal 350 transmitted from leak signal generation component 40 provided in the PIG 10, as further described below.

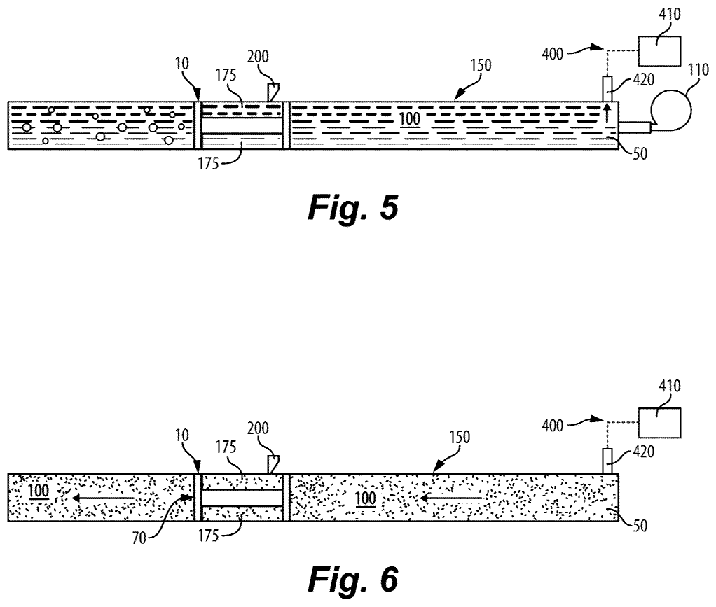

With reference now to FIG. 5, once the leak signal detection assembly 400 detects the aforesaid leak detection signal 350 transmitted from the PIG 10, the leak signal detection assembly 400 preferably causes the PIG 10 to stop movement in the pipeline 150. In certain illustrated embodiments, the leak signal detection assembly 400 causes the PIG to stop movement in the pipeline 150 by stopping the flow of fluid 100 from the first region 10 of the pipeline 150 to the PIG 10 by causing the fluid flow pump 110 to temporarily stop pumping fluid flow 100 in the pipeline 150, which thus stops movement of the PIG 10 when it is caused to be propelled in the pipeline 150 by the fluid flow 100.

In accordance with certain other illustrated embodiments, and with reference now to FIG. 6, when the PIG 10 is provided with the bypass valve component 70 (as described above), upon detection of a leak 200 by the acoustic sensor assembly 30, the acoustic sensor assembly 30 preferably causes the bypass valve component 70 to temporarily move to an open position so as to permit pipeline fluid flow 100 to pass through at least the inner cavity portion 20 of the PIG 10 thereby stopping movement of the PIG 10 in the pipeline 100 since the pipeline fluid flow 100 is unable to provide sufficient pressure against the PIG 10 to cause movement of the PIG 10 in the pipeline 150.

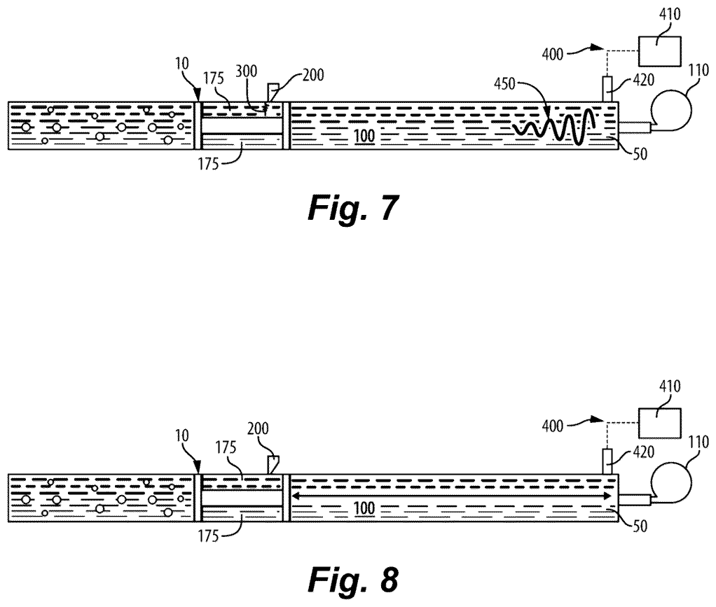

With reference now to FIGS. 7 and 8, once the PIG 10 is preferably caused to stop movement in pipeline 10, so as to maintain a position in the pipeline 150 in close proximity to the PIG 10, the leak signal detection assembly 400 is operative and configured to determine a distance the stopped PIG 10 is from the first region 50 of the pipeline 150. It is to be appreciated and understood, this distance is indicative of the distance the detected leak 200 is from the first region 10 of the pipeline 150. In accordance with the illustrated embodiments, the leak signal detection assembly 400 is preferably configured and operative to detect the distance the PIG 10 is located from the first region 50 of the pipeline 150 by transmitting a distance signal 450 in the pipeline fluid 100. This distance signal 450 (which is preferably a pressure pulse wave) is caused to impact upon the stopped PIG 10, and thus provide an echo returned distance signal back to the leak signal detection assembly 400. Upon detection of this returned echo signal, the leak signal detection assembly 400 is preferably configured and operative to analyze the echo signal to determine the distance it travelled in the pipeline. For instance, a pressure pulse wave 450 typically travels at a rate of 4000 ft/s, thus the total distance such a pressure pulse wave 450 travels in the pipeline 150 can be calculated by determining the time the pressure pulse wave 450 travels to and from the PIG 10. Hence, a distance to the PIG 10 (and thus the detected leak 200) will be half this total distance.

Once the distance to the PIG 10 is determined, the PIG 10 is then preferably caused to resume movement in the pipeline 150 so as to repeat the above process for detecting additional downstream pipeline leaks. For instance, with regard to the embodiment of FIG. 5, whereby a pump 110 was caused to stop the fluid flow 100 in the pipeline 150 for stopping movement of the PIG 10. Upon the aforesaid distance determination by the leak signal detection assembly 400, the leak signal detection assembly 400 preferably instructs the pump 110 to resume pumping fluid flow 100 in the pipeline 150, thus causing the PIG 10 to resume movement in the pipeline 150. And with regard to the illustrated embodiment of FIG. 6, whereby a valve component 70 is caused to open causing pipeline fluid 100 to flow through the PIG 10, thus causing the PIG 10 to stop movement in the pipeline 150. Upon the aforesaid distance determination by the leak signal detection assembly 400, the leak signal detection assembly 400 preferably sends a second signal (e.g., another pulse wave signal) to the PIG 10, which upon reception by the PIG 10, preferably by the acoustic signal processing unit 34, causes the valve component 70 to return to a closed position, thus stopping the pipeline fluid 100 to flow through the PIG 10, thus causing the PIG 10 to resume movement in the pipeline 150.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements. For instance, the determination of detecting a leak 200, as well as determining a location of the detected leak 200 on a pipeline 150, may be performed either locally by the leak signal detection assembly 400, or alternatively by either edge computing and/or cloud computing techniques.

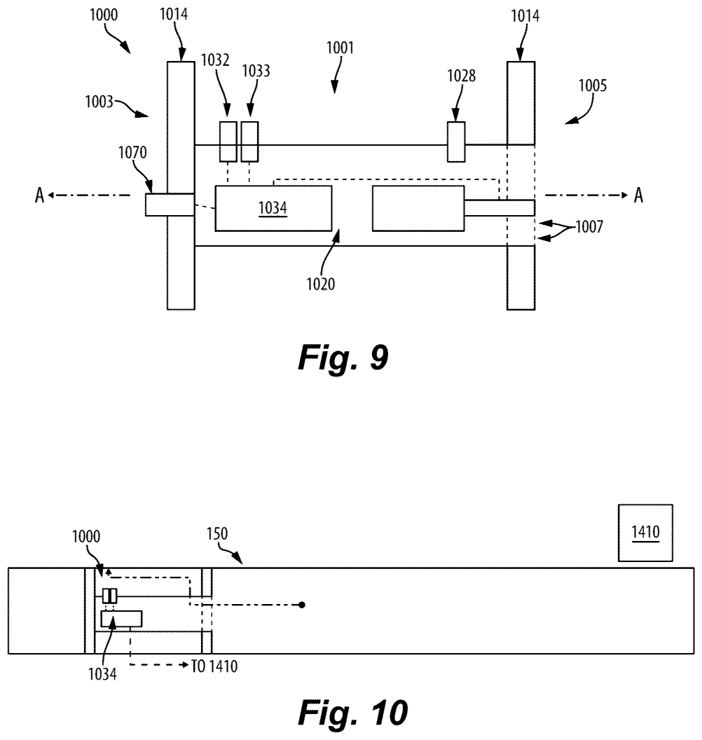

With reference now to FIGS. 9-17b, in accordance with at least one aspect of this disclosure, another embodiment of a Pipeline Inspection Guage (PIG) 1000 for detecting an anomaly in a pipeline carrying fluid is shown. The PIG 1000 can be similar to that shown and described with respect to PIG 10, so similar components described above with respect to PIG 10 will not be repeated in the description of PIG 1000. PIG 1000 comprises a spool shaped housing 1001 having a forward portion 1003 and a rear portion 1005, the forward and rear portions each having an continuous outer wall 1014 configured form a seal with an inner diameter of the pipeline 150 with the PIG 1000 placed in the pipeline 150. A hollow core 1020 extending between the forward portion and the rear portion along an axis A configured to house one or more functional components. In certain embodiments, the one or more functional components can be or include, one or more pressure measuring devices 1032, 1033 for measuring one or more pressure parameters within the fluid 175 flowing through the pipeline to receive pressure signals indicative of the one or more pressure parameters, and a communications module 1034 configured to provide (e.g., issue) an alert to a remote device 1410 indicative of an anomaly detected in the pipeline 150 based on the pressure signals. In certain embodiments, the one or more pressure measuring devices include a fluid pressure transducer 1032 and an acoustic transducer 1033.

In certain embodiments, the rear portion 1005 of the housing 1001 includes one or more flow apertures 1007 defined therein to allow fluid in the pipeline to flow through the rear end 1005 and into the hollow core 1020. In certain such embodiments, the one or more functional components further include: a first valve 1028 disposed in a wall of the hollow core 1020 configured to selectively actuate between an open position and a closed position, and a second valve 1070 disposed in the forward portion 1003 configured to selectively actuate between an open and closed position.

With the first valve 1028 in the open position and the second valve 1070 in the closed position, fluid from the pipeline is permitted to flow from the hollow core into an annular space axially between the forward portion and the rear portion, pushing against the forward portion propelling the PIG through the pipeline. This is shown by the dot-dot-dash arrow in FIG. 10. With the first valve 1028 in the open position and the second valve 1070 in the open position, fluid from the pipeline is permitted to flow from the hollow core into the annular space axially between the forward portion and the rear portion and through the second valve 1070, stalling the PIG in place. In other words, the fluid from the pipeline flows through the PIG. In certain embodiments, the second valve 1070 is configured to automatically actuate from the closed position to the open position upon detection of the anomaly so that the PIG stalls at or near the location of the detected anomaly.

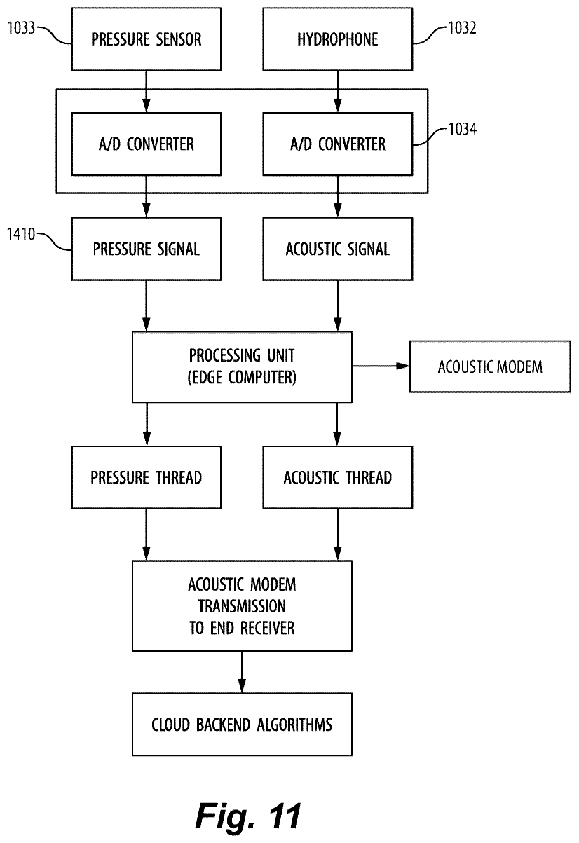

Referring now to FIG. 11, which shows system architecture schematically showing interaction between hardware and software modules, in certain embodiments, the communications module 1034 can further include, a first analog to digital converter configured to convert analog pressure signals indicative of a fluid pressure in the pipeline 150 into a first digital signal stream, and a second analog to digital converter configured to convert analog pressure signals indicative of an acoustic pressure in the pipeline 150 into a second digital signal stream. In certain such embodiments, the communications module 1034 is configured to provide the first digital signal stream and the second digital signal stream to a remote device 1410. Each sensor (e.g., pressure sensor 1033 and hydrophone 1032) can be connected to an independent analog-to-digital (A/D) conversion path to preserve signal fidelity and to allow sampling rates tailored to the measurement type.

In certain embodiments, the remote device 1410 can be an edge computing device whereby each signal stream is siloed within the edge computing device. In certain such embodiments, the edge computing device 1410 can be configured to sample the first signal stream at a first sampling rate (e.g., a rate sufficient to capture pressure fluctuations relevant to leak detection and flow disturbances without generating excessive data volume) and sample the second signal stream at a second sampling rate different from the first sampling rate (e.g., a rate enabling detection of acoustic signatures of interest by capturing transient acoustic signals associated with leaks, pig passage, or other anomalies in the system). The first sampling rate and the second sampling rate can be determined as a function of signal type. For example, the first sampling rate (for sampling the fluid pressure measurements) can be at a rate of about 1 kHz while the second sampling rate (for sampling the acoustic pressure measurements) can be higher, at a rate of about 60 kHz.

As shown in FIG. 11, the sensor streams are ingested by the edge computing device that applies timestamps, buffers incoming data, and executes parallel acquisition threads for the two modalities. Detection algorithms preferably operate independently on pressure data and the acoustic data, applying thresholds and criteria specific to leak events, pig tracking signatures, or other operational anomalies, and independent detections are transmitted as event summaries, as will be explained in further detail below. A telemetry thread manages outbound communications.

It is to be understood and appreciated that processing at the edge (e.g., 1410) conserves bandwidth, reduces power usage, and enables timely detection and reporting.

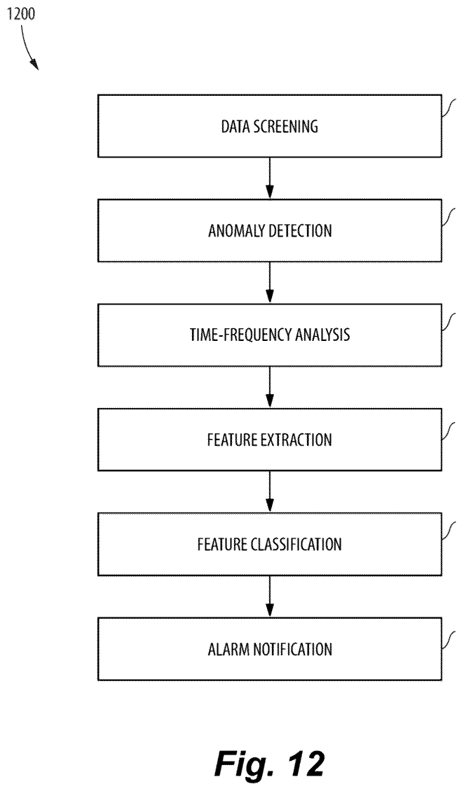

Referring now to FIGS. 12-18b, FIG. 12 shows a schematic diagram of a workflow 1200 for the edge computing device 1410, for example showing both pressure and acoustic sensor real-time signal processing during a PIG 1000 run for pre-existing leak detection. Data screening 1210 preferably applies statistical model and filtering techniques to raw or scaled measurement data fed through sliding window. Anomaly detection 1215 can be threshold based, either single or variable, and performed in conjunction with other system configuration parameters. In certain embodiments, the edge computing device 1410 can be configured to per employ a first detection algorithm on signal data from the first signal stream to determine whether an anomaly is present in the pipeline based on the comparison of the fluid pressure signals to a first anomaly detection threshold, and employ a second detection algorithm on signal data from the second signal stream to determine whether an anomaly is present in the pipeline based on the comparison of the acoustic pressure signals to a second anomaly detection threshold.

In certain embodiments, the edge computing device 1410 can be further configured to, after an anomaly is detected by either of the first detection algorithm or the second detection algorithm, capture a portion of the signal stream indicating the anomaly as an anomaly window and perform one or more data processing techniques on the anomaly window to determine whether the anomaly is an anomaly requiring action by a user. In certain embodiments, the one or more data processing techniques can include any one or combination of the following described techniques.

With continuing reference to FIG. 12, in certain embodiments, the one or more data processing techniques can include performing time-frequency analysis 1220 on the anomaly window using continuous wavelet transform to obtain calculated values quantifying a presence and an intensity of an anomaly signature within the anomaly by comparing the calculated values to the first anomaly threshold and/or the second anomaly detection threshold. For example, time-frequency analysis can be performed using Continuous Wavelet Transform (CWT). The CWT analyzes a signal by comparing it to a set of basis functions called wavelets. These wavelets are scaled (stretched or shrunk) and translated (shifted in time or position) versions of a mother wavelet. The results of this comparison are represented by CWT Coefficients (CFS). They are the calculated values that quantify the presence and intensity of different frequency components (at various scales) within a signal at different points in time or position when using the CWT.

In certain embodiments, the one or more data processing techniques can include performing feature extraction 1225 on the anomaly signature using principal component analysis to identify components of the anomaly signature of high significance by assigning a respective significance score. In certain embodiments, feature extraction 1225 extracts features from CFS and implemented by Principal Component Analysis (PCA). It is noted wavelet transforms excel at representing signals at different scales and frequencies. The coefficients at various levels capture different aspects of the signal, such as fine details (high frequencies) and overall trends (low frequencies). PCA can then be used to reduce the dimensionality of these wavelet coefficients, identifying the most significant components (representing the most important features) while minimizing information loss. This approach can be particularly beneficial when dealing with large datasets or signals containing a significant amount of information, making them easier to analyze and process. To implement feature extraction, CFS to PCA transformation model is preferably built offline through training in advance, then uploaded for online real-time signal processing directly.

In certain embodiments, the one or more data processing techniques can include performing feature classification 1230 using one or more artificial intelligence (AI) techniques to classify the components of the anomaly signature having a high significance score as one or more predetermined anomaly types based on their respective significance score. Feature Classification can be also driven by pre-trained model using PCA inputs. The model type can be Partial-Least-Square (PLS), Vector-Support-Machine (VSM), Neural Network (NN), Adaptive Neuro-Fuzzy Inference System (ANFIS) or decision trees. The outputs of classification model can be one or more of the following predetermined anomaly types: pre-existing leak, pig-sig, farm tap, dresser, weld spot and others. Unsupervised clustering techniques can also be used to group converted PCA inputs into different classes without pre-assignment, especially for post-processing of measurement data to identify or validate leak signatures.

In certain embodiments, the edge computing device 1410 can be further configured to, upon detection of the anomaly, automatically generate an event report of an anomaly having a significance score matching one of the predetermined anomaly types in either the first signal stream or the second signal stream where the event report identifies the anomaly type. The edge computing device can autonomously generate event summaries whenever an anomaly is detected by either sensor modality and these summaries can be transmitted without the underlying raw streams, ensuring that only relevant and time-critical information is communicated. In certain embodiments, after a leak point is identified, an alarm notification 1235 can be transmitted through additional device, mechanism or media for further location determination, or saved for later post-processing. In certain embodiments, a low-bandwidth acoustic modem provides communication with a remote receiver. The modem may be used exclusively for event alerts and periodic heartbeat signals confirming system health. It is to be understood and appreciated that limiting transmissions to anomaly-driven reports and scheduled status updates, the modem's restricted bandwidth is used efficiently and reliably. This arrangement enables high-resolution sensing and processing to occur locally, while communication is limited to anomaly-driven summaries, making the system particularly well-suited for applications such as leak detection and pig tracking in bandwidth- and energy-constrained environments.

In certain embodiments, such as shown in FIGS. 1-10, the one or more functional components can further include an alert assembly positioned within the hollow core closer to the rear portion than the forward portion, the alert assembly may include a third valve 44, 1044 configured to acuate upon detection of an anomaly within the pipeline (e.g., 150). Actuation of the third valve (e.g., 44, 1044) generates a pressure pulse signal, into the fluid provided in the pipeline (e.g., 150) and through the fluid in the pipeline to a remote device (e.g., 1410).

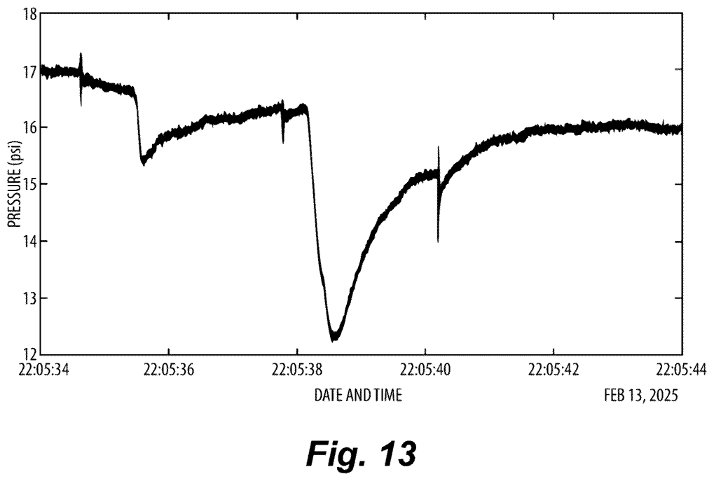

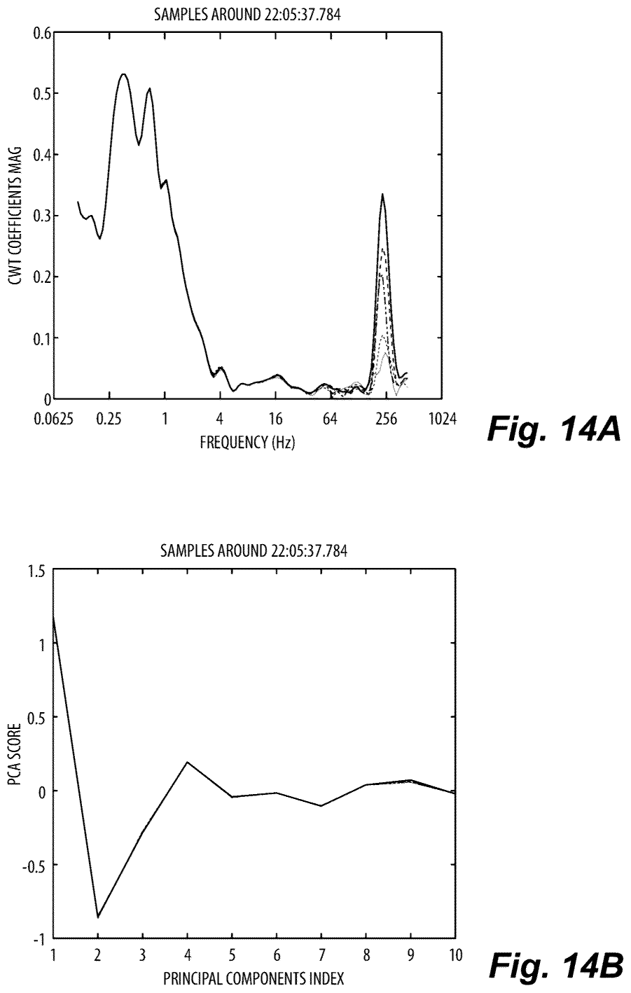

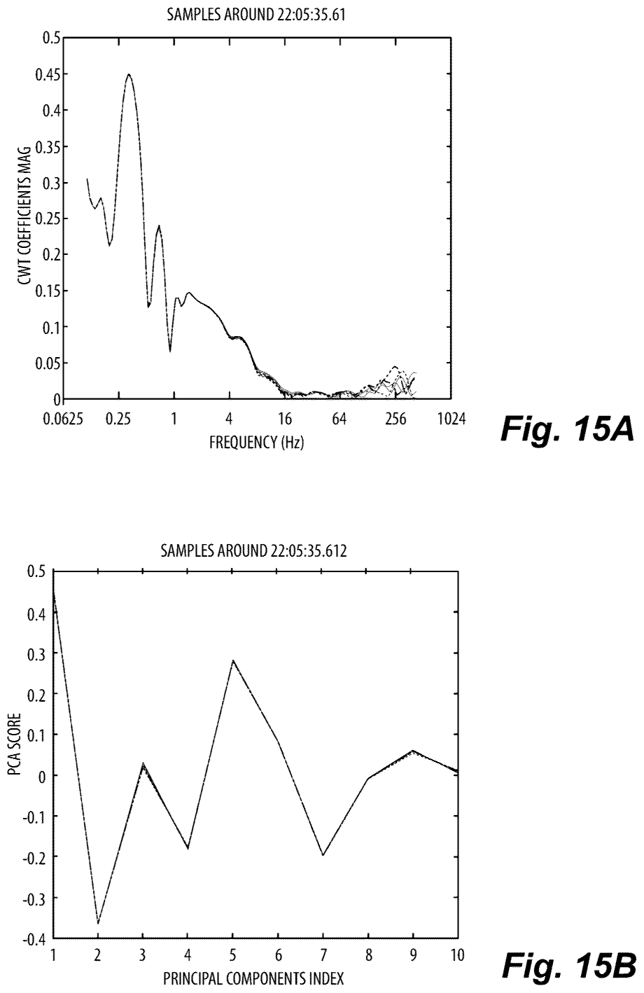

With reference now to FIG. 13, it depicts a short interval of pressure measurement data during a test with transducer attached to a moving PIG (e.g., 1000). Multiple anomaly points are preferably triggered for CWT analysis. For instance, the sampling rate of pressure measurements is 1000 Hz in this test. FIGS. 14a and 14b displays CWT coefficients magnitude as a function of 120 frequency components around a pig-sig point, which is an indicator of pig passage, and the extracted PCA score of the first 10 principal components. In PCA, scores represent the coordinates of the data points projected onto the new axes (principal components). These scores indicate how much each data point contributes to each principal component, effectively transforming the original data into a new space defined by the principal components. In this example, the first 10 components explain more than 98 percent of signal variation presented in CWT coefficients against 120 frequency components. Same analysis is applied to a leak point with results displayed in FIG. 15a and FIG. 15b. It can be seen from FIGS. 14a, 14b, 15a, and 15b that the pig-sig and leak points can be differentiated from its CWT coefficients and principal components. As one embodiment of this invention, principal components derived from CWT coefficients are used as inputs to classify a variety of pigging signatures for pre-existing leak detection. It is to be understood and appreciated this method can be applied to both moving sensors and stationary sensors installed at upstream (launcher site) and downstream (receiver site) end points of pigging operation. It is to be appreciated that one having ordinary skill in the art in view of this disclosure, would understand that CWT coefficients array is different from traditional Power Spectral Density (PSD) for feature extraction.

It is to be understood and appreciated that PSD primarily reveals the dominant frequencies present in a signal and their relative power, and it is useful for analyzing signals with stationary frequency content (where the frequencies don't change much over time). It does not provide information about when specific frequencies occur in time. Rather, it is essentially an average across the entire signal's duration. In comparison, CWT coefficients array reveals how the frequency content of a signal changes over time. It can pinpoint transient events, sudden changes in frequency, and how different frequency components evolve through the signal's duration. It has advantages of time-frequency localization and is better than PSD for analyzing non-stationary signals (signals whose frequency content changes over time). It is also superior in multi-resolution analysis, can capture signal features at different scales, allowing for both fine and broad analysis of the signal's characteristics.

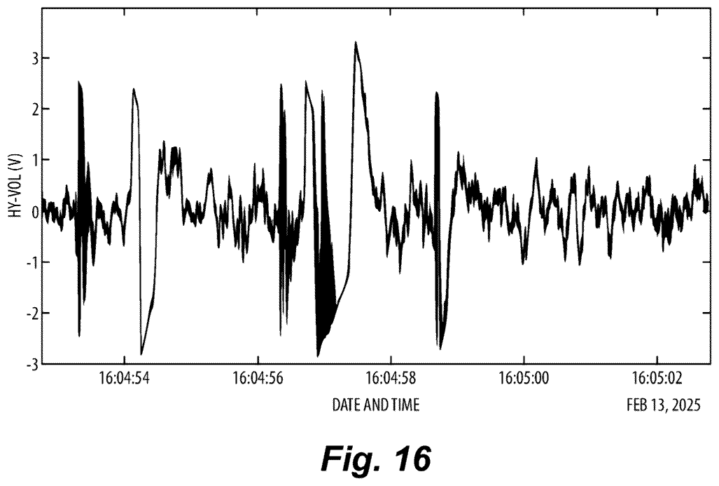

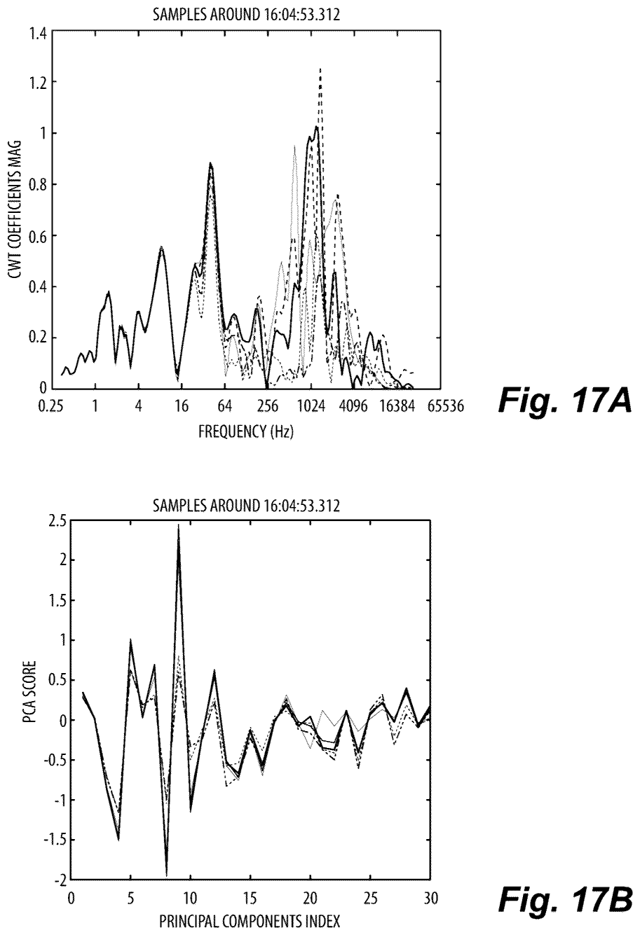

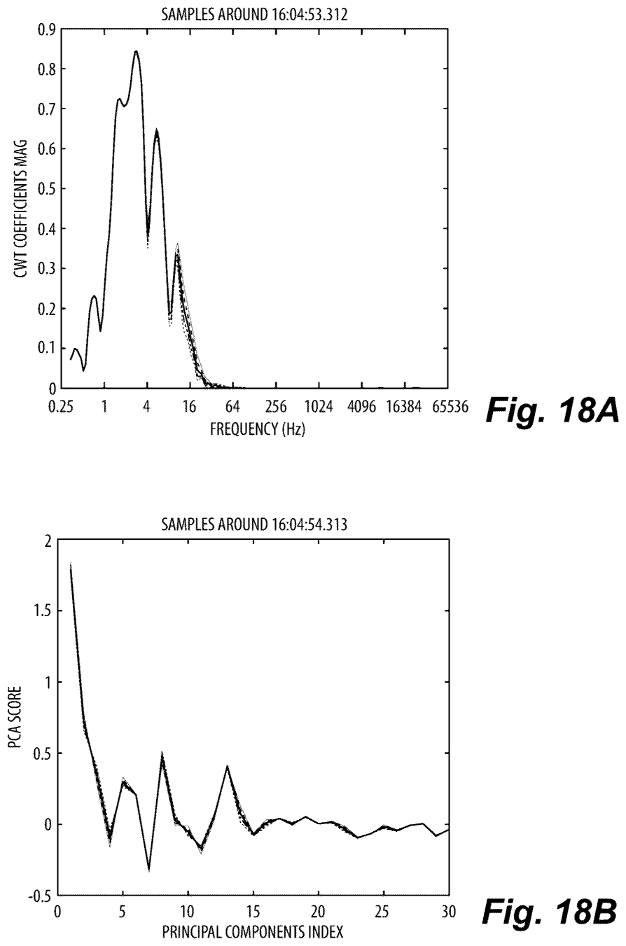

FIG. 16 shows a short interval of acoustic measurement data in output voltage during a test with hydrophone attached to a moving PIG (e.g., 1000). It is noted the sampling rate of hydrophone measurements is 60 KHz in this test. FIGS. 17a and 17b displays CWT coefficients magnitude as a function of 164 frequency components around a pig-sig point, and the extracted PCA score of the first 30 principal components. In this example, the first 30 components explain more than 95 percent of signal variation presented in CWT coefficients against 164 frequency components. The same analysis is applied to a leak point with results displayed in FIGS. 18a and 18b. In this example, pressure and acoustic transducer data presented in FIGS. 13 and 16 were recorded over the same pig travel distance with different reference times. Their trigger point signatures were correlated in time, but acoustic signals have more high frequency components during transients. While extracted features can be represented by only 10 principal components for pressure measurements, they require 30 principal components for hydrophone data representation due to the complexity of acoustic signal processing. Therefore, while not always mandatory, filtering in pre-processing is often a valuable step before applying CWT to improve acoustic signal quality, focus the analysis on specific frequency bands, and enhance feature extraction. In certain embodiments of this invention (e.g., as described above), a pressure transducer is used in conjunction with an acoustic sensor to validate classification output each other or prefer one than other in different applications (pressure transducer for liquid and acoustic transducer for gas, for example).

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features.

The foregoing description should therefore be considered as merely illustrative of the principles, teachings and exemplary embodiments of this invention, and not in limitation thereof.

What is claimed is:

1. A computer-implemented system for detecting an anomaly in a pipeline carrying fluids using a Pipeline Inspection Guage (PIG), comprising:
a PIG configured to be placed into a fluid within the pipeline;
one or more pressure measuring devices configured to receive pressure signals indicative of the one or more pressure parameter within the fluid flowing through the pipeline; and
a processor configured to:
provide the pressure signals to an edge computing device for comparing the pressure signals to one or more anomaly detection thresholds to determine whether an anomaly is detected in the pipeline;
automatically generate an event report upon detection of the anomaly; and
automatically issue an alert in the form of an event summary describing the anomaly.

2. The system of claim 1, wherein the one or more pressure parameters includes a fluid pressure and the one or more pressure measuring devices includes a fluid pressure sensor.

3. The system of claim 2, wherein the one or more pressure parameters further includes an acoustic pressure measurement and the one or more pressure measuring devices further includes a hydrophone.

4. The system of claim 3, wherein the fluid pressure sensor and the acoustic pressure sensor are further configured to simultaneously and continuously measure both a fluid pressure and an acoustic pressure within the fluid flowing through the pipeline while the PIG is in the pipeline, and wherein the one or more pressure signals include fluid pressure signals indicative of the fluid pressure and acoustic pressure signals indicative of the acoustic pressure, and the processor is further configured to:
convert the one or more pressure signals from analog pressure signals to digital pressure signals, wherein
the fluid pressure signals indicative of the fluid pressure are converted via a first signal analog to digital converter and provided to the edge computing device via a first signal stream, and
the acoustic pressure signals indicative of the acoustic pressure are converted via a second analog to digital converter and provided to the edge computing device via a second signal stream.

5. The system of claim 4, wherein each signal stream is siloed within the edge computing device.

6. The system of claim 4, wherein the edge computing device is configured to sample the first signal stream at a first sampling rate and sample the second signal stream at a second sampling rate different from the first sampling rate, wherein the first sampling rate and second sampling rate are determined as a function of signal type.

7. The method of claim 5, wherein the edge computing device is further configured to:
employ a first detection algorithm on signal data from the first signal stream to determine whether an anomaly is present in the pipeline based on the comparison of the fluid pressure signals to a first anomaly detection threshold;
employ a second detection algorithm on signal data from the second signal stream to determine whether an anomaly is present in the pipeline based on the comparison of the acoustic pressure signals to a second anomaly detection threshold.

8. The system of claim 7, wherein the edge computing device is further configured to, after an anomaly is detected by either of the first detection algorithm or the second detection algorithm,
capture a portion of the signal stream indicating the anomaly as an anomaly window; and
perform one or more data processing techniques on the anomaly window to determine whether the anomaly is an anomaly requiring action by a user, the one or more data processing techniques including:
performing time-frequency analysis on the anomaly window using continuous wavelet transform to obtain calculated values quantifying a presence and an intensity of an anomaly signature within the anomaly by comparing the calculated values to the first anomaly threshold and/or the a second anomaly detection threshold;
performing feature extraction on the anomaly signature using principal component analysis to identify components of the anomaly signature of high significance by assigning a respective significance score; and
performing feature classification using one or more artificial intelligence (AI) techniques to classify the components of the anomaly signature of having a high significance score as one or more predetermined anomaly types based on their respective significance score.

9. The system of claim 8, wherein the one or more predetermined anomaly types include: a newly identified leak, a pre-existing leak, a pig-sig, a farm tap, a dresser, and/or a weld spot.

10. The system of claim 9, wherein the processor is further configured to automatically generate the event report upon detection of an anomaly having a significance score matching one of the predetermined anomaly types in either the first signal stream or the second signal stream where the event report identifies the anomaly type.

11. The system of claim 10, wherein the processor is further configured to issue the alert via a low bandwidth acoustic modem to a remote receiver dedicated to receiving the event report.

12. A Pipeline Inspection Guage (PIG) for detecting an anomaly in a pipeline carrying fluid, comprising:
a spool shaped housing having a forward portion and a rear portion, the forward and rear portions each having an outer wall configured form a seal with an inner diameter of the pipeline with the PIG placed in the pipeline;
a hollow core extending between the forward portion and the rear portion along an axis configured to house one or more functional components, the one or more functional components including:
one or more pressure measuring devices for measuring one or more pressure parameters within the fluid flowing through the pipeline to receive pressure signals indicative of the one or more pressure parameters; and
a communications module configured to provide issue an alert to a remote device indicative of an anomaly detected in the pipeline based on the pressure signals.

13. The PIG of claim 12, wherein one or more pressure measuring devices include a fluid pressure transducer and an acoustic transducer.

14. The PIG of claim 13, wherein the rear portion includes one or more flow apertures defined therein to allow fluid in the pipeline to flow through the rear end and into the hollow core, and wherein the one or more functional components further include:
a first valve disposed in a wall of the hollow core configured to selectively actuate between an open position and a closed position; and
a second valve disposed in the forward portion configured to selectively actuate between an open and closed position, wherein
with the first valve in the open position and the second valve in the closed position, fluid from the pipeline is permitted to flow from the hollow core into an annular space axially between the forward portion and the rear portion, pushing against the forward portion propelling the PIG through the pipeline, and
with the first valve in the open position and the second valve in the open position, fluid from the pipeline is permitted to flow from the hollow core into the annular space axially between the forward portion and the rear portion and through the second valve, stalling the PIG in place,
wherein the second valve is configured to automatically actuate from the closed position to the open position upon detection of the anomoly.

15. The PIG of claim 14, wherein the communications module further includes:
a first analog to digital converter configured to convert analog pressure signals indicative of a fluid pressure in the pipeline into a first digital signal stream, and
a second analog to digital converter configured to convert analog pressure signals indicative of an acoustic pressure in the pipeline into a second digital signal stream,
wherein the communications module is configured to provide the first digital signal stream and the second digital signal stream to the remote device.

16. The PIG of claim 15, wherein the remote device is an edge computing device and wherein each signal stream is siloed within the edge computing device,
wherein the edge computing device is configured to sample the first signal stream at a first sampling rate and sample the second signal stream at a second sampling rate different from the first sampling rate, wherein the first sampling rate and second sampling rate are determined as a function of signal type.

17. The PIG of claim 16, further comprising, the edge computing device,
wherein the edge computing device is configured to employ a first detection algorithm on signal data from the first signal stream to determine whether an anomaly is present in the pipeline based on the comparison of the fluid pressure signals to a first anomaly detection threshold; and
employ a second detection algorithm on signal data from the second signal stream to determine whether an anomaly is present in the pipeline based on the comparison of the acoustic pressure signals to a second anomaly detection threshold.

18. The PIG of claim 17, wherein the edge computing device is further configured to, after an anomaly is detected by either of the first detection algorithm or the second detection algorithm,
capture a portion of the signal stream indicating the anomaly as an anomaly window; and
perform one or more data processing techniques on the anomaly window to determine whether the anomaly is an anomaly requiring action by a user, the one or more data processing techniques including:
perform time-frequency analysis on the anomaly window using continuous wavelet transform to obtain calculated values quantifying a presence and an intensity of an anomaly signature within the anomaly by comparing the calculated values to the first anomaly threshold and/or the second anomaly detection threshold;
perform feature extraction on the anomaly signature using principal component analysis to identify components of the anomaly signature of high significance by assigning a respective significance score; and
perform feature classification using one or more artificial intelligence (AI) techniques to classify the components of the anomaly signature of having a high significance score as one or more predetermined anomaly types based on their respective significance score.

19. The PIG of claim 18, wherein the one or more predetermined anomaly types include: a newly identified leak, a pre-existing leak, a pig-sig, a farm tap, a dresser, and/or a weld spot.

20. The PIG of claim 19, wherein the edge computing device is further configured to, upon detection of the anomaly, automatically generate an event report of an anomaly having a significance score matching one of the predetermined anomaly types in either the first signal stream or the second signal stream where the event report identifies the anomaly type.

21. The PIG of claim 14, wherein the one or more functional components further includes an alert assembly positioned within the hollow core closer to the rear portion than the forward portion, the alert assembly including a third valve configured to acuate upon detection of an anomaly within the pipeline, wherein actuation of the third valve generates a pressure pulse signal, into the fluid provided in the pipeline and through the fluid in the pipeline to the remote device.
